(19) United States
(12) Patent Application Publication
(10) Pub. No.: US 2010/0126831 A1
(43) Pub. Date: May 27, 2010

(54) SELF CLEANING BELT CONVEYOR

(75) Inventor: Hans Peter Theodorus Ceelen, Rio Vista, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/626,261

(22) Filed: Nov. 25, 2009

Related U.S. Application Data
(60) Provisional application No. 61/118,225, filed on Nov. 26, 2008.

(51) Int. Cl. B65G 45/18; B65G 15/30; B65G 17/02; B65G 15/20; B65G 17/30; B65G 17/26

(52) U.S. Cl. 198/496; 198/844.1; 198/617; 198/606

(57) ABSTRACT

Apparatus and methods relating to a self cleaning belt conveyor for transporting a substrate through a chamber are provided. One embodiment of the apparatus provides a belt conveyor apparatus for transporting a substrate through a chamber comprising at least one endless belt having a conveying surface, wherein the conveying surface comprises one or more raised components for supporting the substrate and maintaining a gap between the conveying surface and the substrate, and two or more cylindrical shafts coupled with the at least one endless belt wherein the at least one endless belt is tensioned around the two or more cylindrical shafts and wherein the two or more cylindrical shafts are rotatable to move the conveying surface.

### CROSS-REFERENCE TO RELATED APPLICATIONS

This application claims benefit of U.S. provisional patent application Ser. No. 61/118,225, filed Nov. 26, 2008, which is herein incorporated by reference.

### BACKGROUND OF THE INVENTION

1. Field of the Invention

Embodiments of the present invention generally relate to belt conveyors and, more particularly, to self cleaning belt conveyors.

2. Description of the Related Art

Typically, during the transporting of glass substrates through vacuum processing chambers, excess deposition material which is sputtered or sprayed onto the substrates tends to deposit on the floor of the sputter area, which usually has spaced apart conveyor wheels protruding through it. This deposited excess material may build up to the point that it clogs up the conveyor wheels, necessitating stopping the processing chamber, venting it, tearing it apart, cleaning it out, replacing parts, and restarting the process. This cleaning interruption leads to much down-time.

Currently used chamber configurations for catching the excess material that accumulates during the deposition process include a static lower floor, such as in a conductance limiting tunnel, or a static deposition shield. However, these configurations all require frequent cleaning of the chamber every time an excess amount of material clogs up the chamber operating space.

In a fixed-floor chamber arrangement or configuration, it is desirable to have the lower floor as close as possible to the glass substrate so as to avoid backside sputtering caused by deposited material wrapping around the conveyor wheels. However, when the floor is very close to the glass substrate, there is less room for depositing excess material before running out of space, so that the chamber must be cleaned out more frequently. Oftentimes, operators will assume the risk of backside sputtering in order to be able to run the system for longer periods of time without having to interrupt the process to clean up accumulated deposits, thereby compromising process control.

Therefore, there is a need for an apparatus and method of transporting substrates through processing chambers that minimizes cleaning of excess deposited material in order to reduce process down-time and enhance process control.

### SUMMARY OF THE INVENTION

Embodiments described herein generally relate to belt conveyors and, more particularly, to self cleaning belt conveyors. In one embodiment, a belt conveyor apparatus for transporting a substrate through a chamber is provided. The belt conveyor comprises at least one endless belt having a conveying surface, wherein the conveying surface comprises one or more raised components for supporting the substrate and maintaining a gap between the conveying surface and the substrate. The belt conveyor further comprises two or more cylindrical shafts coupled with the at least one endless belt wherein the at least one endless belt is tensioned around the two or more cylindrical shafts and wherein the two or more cylindrical shafts are rotatable to move the conveying surface.

In another embodiment, a belt conveyor apparatus for transporting a substrate through a chamber is provided. The belt conveyor comprises a frame, at least two drive shafts supported by the frame and connectable to a motor, and at least two parallel chains, wherein each chain is actively engaged with at least two sprockets operatively coupled with the at least two drive shafts. The belt conveyor further comprises a caterpillar track having a conveying surface, wherein the caterpillar track is mounted on the at least two parallel chains such that the caterpillar track is rotatable around the at least two drive shafts during rotation of the at least two drive shafts, and wherein the caterpillar track comprises at least one raised component on the conveying surface to form a gap between the conveying surface and the substrate.

In yet another embodiment, an apparatus for transporting a substrate through a chamber is provided, the apparatus comprising a chain driven assembly for rotating a caterpillar track around at least two drive shafts, wherein the assembly is driven by the at least two drive shafts using at least two parallel chains, wherein each chain is mechanically engaged to at least two sprockets coupled with each drive shaft, and wherein the caterpillar track has a conveying surface comprising one or more raised components for supporting the substrate.

In another embodiment, a method of conveying a substrate from a starting point to a destination point along a path is also provided, comprising placing a substrate on a belt conveyor. The belt conveyor may comprise a frame, at least two motorized drive shafts supported by the frame and connectable to a motor, and at least two parallel chains, wherein each chain is actively engaged with at least two sprockets coupled with the at least two drive shafts. The belt conveyor may also comprise a caterpillar track, wherein the caterpillar track is coupled with the at least two parallel chains and has a conveying surface comprising at least one raised component for supporting the substrate and wherein the caterpillar track provides a substrate-conveying stretch and a return stretch. The method further comprises rotating the at least two drive shafts to move the sprockets and the at least two parallel chains such that the caterpillar track is driven around the at least two drive shafts, wherein the conveying surface moves along the path and material deposited on the conveying surface peels off of the conveying surface. The substrate moves on the conveying surface along the belt conveyor.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an elevated side view of one embodiment of a self cleaning belt conveyor;

FIG. 2 is a cross-sectional view of an embodiment of a self cleaning belt conveyor, as positioned under a chamber sputtering device;

FIG. 3 is an enlarged partial side cross-sectional view of a section of one embodiment of a self cleaning belt conveyor;

FIG. 4 is an elevated side view of one embodiment of a self cleaning belt conveyor;

FIG. 5 is an elevated side view of a slat of a caterpillar track of one embodiment of a self cleaning belt conveyor;

FIG. 6 is an elevated side view of a slat of a caterpillar track of one embodiment of a self cleaning belt conveyor;

FIG. 7A is an elevated side view showing detail of one embodiment of a self cleaning belt conveyor;

FIG. 7B is a magnified elevated side view showing detail of one embodiment of a self cleaning belt conveyor; and

FIG. 8 is an elevated side view of one embodiment of a self cleaning belt conveyor.

It is contemplated that elements disclosed in one embodiment may be beneficially utilized in other embodiments without specific recitation.

### DETAILED DESCRIPTION

Embodiments described herein provide apparatus and methods relating to belt conveyors and, more particularly, to self cleaning belt conveyors.

One embodiment of a belt conveyor apparatus described herein provides a conveying surface on a conveying belt comprising one or more raised elastomeric areas thereon for releasably supporting a substrate and facilitating peeling of excess deposited material from the conveying belt. The substrate may be, for example, a glass substrate. The raised elastomeric areas on the conveying surface may support the glass substrate as it is conveyed through a chamber, such as a deposition chamber, and allow for easy removal of the glass substrate from the conveying surface at the point of destination. As the conveying belt bends around the rollers on the return stretch, accumulated excess material, such as a metal, deposited on the conveying surface tends to peel or flake away from the conveying surface and falls to the floor of a deposition zone. The raised elastomeric areas may enhance the peeling of the deposited material from the conveying surface as the conveying belt bends around the rollers.

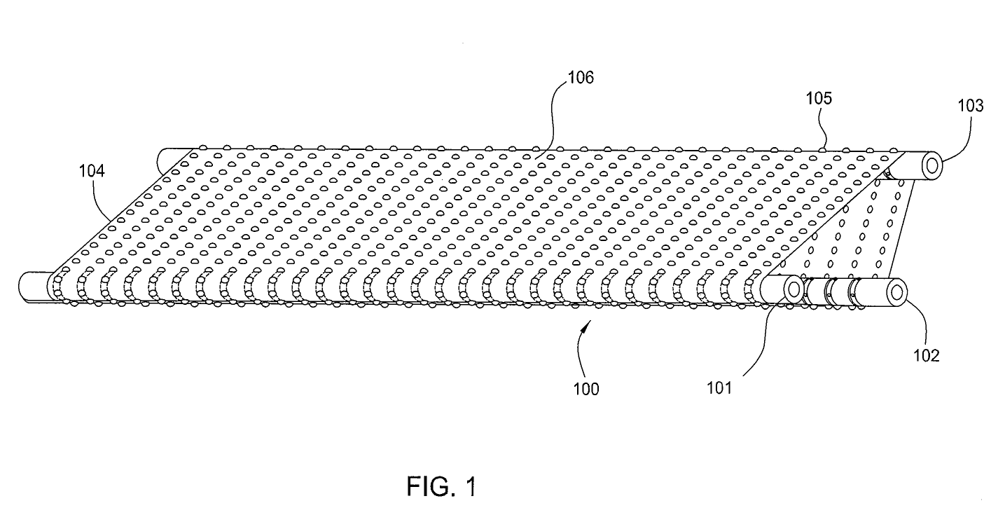

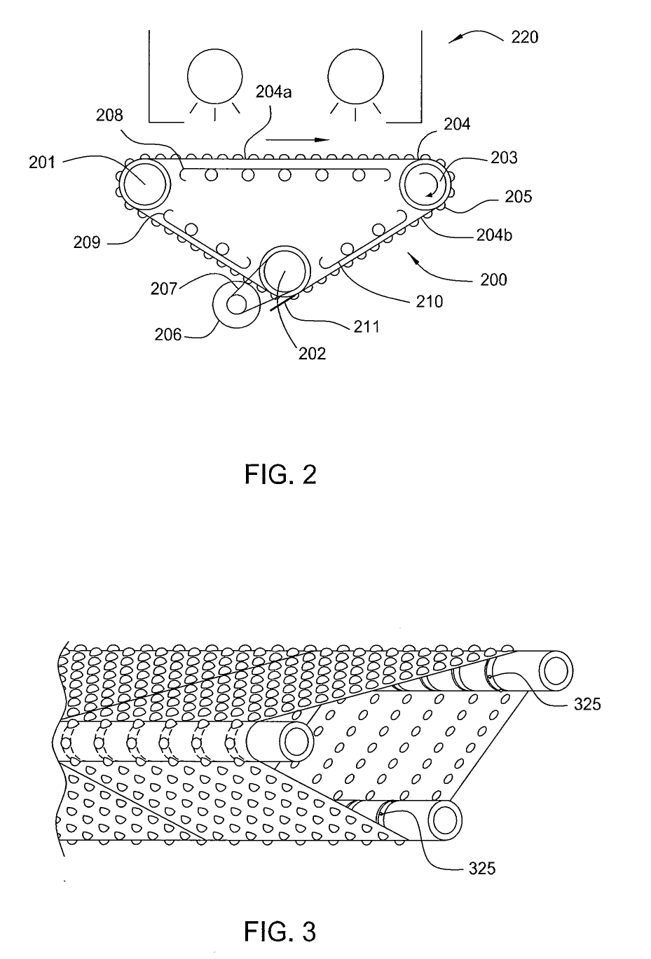

FIG. 1 is an elevated side view of one embodiment of a self cleaning belt conveyor. The belt conveyor 100 comprises at least three rollers 101, 102 and 103 positioned in space parallel to each other but not aligned with one another, so as to form a triangular cross section (see FIG. 2). In other embodiments, belt conveyor 100 may comprise four rollers, or five rollers, or more. Rollers 101, 102 and 103 may be made of metal such as stainless steel or aluminum. Rollers 101, 102 and 103 may be cylindrical in shape and able to be rotated. In one embodiment, rollers 101, 102 and 103 may be solid tubes or cylinders. In another embodiment, rollers 101, 102 and 103 may be hollow tubes or cylinders. Rollers 101, 102 and 103 may be made of a conductive material. In another embodiment, rollers 101, 102 and 103 may have an insulating material, such as rubber or an elastomer, surrounding the outer surface of each roller so as to make each roller nonconductive. Alternatively, rollers 101, 102 and 103 may be made of a nonconductive material. One of rollers 101, 102 and 103 may be driven by, for example, a motor (not shown), while the remaining rollers may be idle. Rollers 101, 102 and 103 may be supported by a conveyor frame (not shown). In one embodiment, one or more of the rollers 101, 102, or 103 may have one or more crowns or bumps 325 protruding from their exterior surface to assist in tracking the conveying belt (see FIG. 3).

At least one endless conveying belt 104 may be extended and tensioned around rollers 101, 102 and 103. In one embodiment, roller 102 is positioned below and between rollers 101 and 103 so that roller 102 may function as a tensioning mechanism for conveying belt 104. Conveying belt 104 may be made of metal, which may be thin and solid. In one embodiment, conveying belt 104 may be made of a woven material, such as a fabric or woven metal, and may be reinforced. In yet another embodiment, conveying belt 104 may be made of a material of sufficient roughness so as to cause the material deposited on the conveying belt 104 to grow thicker prior to it peeling or flaking away from the conveying belt 104. In another embodiment, conveying belt 104 may have a surface treatment applied to it so as to make it less sticky to minimize adhesion of the deposited material.

In yet another embodiment, conveying belt 104 may have one or more areas of elastomeric material, such as rubber or silicon, which are raised from the conveying surface 106 so as to releasably support a substrate being conveyed on the conveying belt 104 and to enhance the ability of the conveying surface 106 to shed deposited material. These one or more areas of raised elastomeric material may span the length and width of conveying belt 104. As shown in FIG. 1, conveying belt 104 may have buttons or studs 105 (one exemplary stud is labeled 105 in FIG. 1) made of an elastomeric material, such as rubber or silicon. It should be noted that the raised areas of elastomeric material are not limited to a specific shape, such as buttons or studs. In one embodiment, the raised areas of elastomeric material may be shaped as squares, or stripes, or triangles, or ellipses, or a grid, or any other shape or combination thereof. It should also be noted that the raised areas of elastomeric material are not limited to a specific size. It is desirable that the raised areas of elastomeric material be sufficiently concentrated or close together and span enough of the width and length of the conveying surface 106 of conveying belt 104 so as to releasably support a substrate being conveyed on the conveying belt 104 and to enhance the ability of the conveying surface 106 to shed deposited material.

In one embodiment, multiple endless conveying belts may be positioned adjacent to one another and extended under tension around the motorized roller and the at least two other rollers. It is desirable that for embodiments of the belt conveyor having multiple belts around the rollers, there is little to no space between each adjacent belt, so as to not expose the areas under the belt and within the belt conveyor to deposited material in situations where, for example, the conveying belt passes through a deposition chamber. In one example, four endless conveying belts may be placed side-by-side and extended under tension around the rollers. In another example, a dozen endless conveying belts may be placed side-by-side and extended under tension around the rollers. In another embodiment, multiple belts may be positioned longitudinally end to end so as to form one endless conveying belt which can be extended under tension around the rollers. In one embodiment, each of the multiple belts may have one row of raised areas of elastomeric material, such as elastomeric studs or buttons, as described above.

In one embodiment, conveying belt 104 may be grounded. In another embodiment, conveying belt 104 may be floating. In one embodiment, conveying belt 104 may be magnetic. In another embodiment, conveying belt 104 may be nonmagnetic.

Rollers 101, 102 and 103 may have a diameter sufficiently small to encourage peeling of excess deposited material from the conveying belt 104, yet sufficiently large to support conveying belt 104 without compromising its structure, depending on the fatigue life and mechanical strength of conveying belt 104. It is desirable that the diameter of rollers 101, 102 and 103 be large enough so that conveying belt 104 has an appreciably long life.

FIG. 2 is a cross-sectional view of an embodiment of a self cleaning belt conveyor 200, as positioned under a chamber sputtering device 220. Conveying belt 204 extends around rollers 201, 202 and 203. In one embodiment, roller 203 may be driven by a motor (not shown). In another embodiment, roller 201 or roller 202 may be driven by a motor. Although only three rollers are shown in FIG. 2, it should be appreciated that more than three rollers may be used in the belt conveyor, as explained above. Conveying belt 204 may be tensioned around rollers 201, 202 and 203 in any customary manner. In one embodiment, bottom roller 202 may have adjustable mounting or be adjustable in some other manner so as to serve as a tension mechanism for the conveying belt 204. Upper conveying stretch 204a of the conveying belt 204 between rollers 201 and 203 may carry a glass substrate to the right (as indicated by the arrow) along a predetermined path from a starting point to a destination point. Return stretch 204b may be the path formed by conveying belt 204 when looped around roller 202 and tensioned between rollers 201 and 203.

A substrate, such as glass, may be placed on conveying belt 204 such that it is releasably supported by raised areas of elastomeric material, such as elastomeric studs or buttons 205 (only one exemplary stud 205 is labeled in FIG. 2). As shown in FIG. 2, it is desirable to have the raised areas of elastomeric material, such as multiple elastomeric studs or buttons, spanning the overall width and length of the conveying surface. It should also be noted, as explained above, that the raised areas of elastomeric material are not limited to a specific shape, such as buttons or studs, or size. In one embodiment, conveying belt 204 conveys a substrate to the right (as indicated by the arrow) along conveying stretch 204a while a sputtering device 220 may deposit a material, such as a metal, onto the substrate. Some of the material may also be deposited on the conveying belt 204. As conveying belt 204 reaches roller 203, conveying belt 204 will bend around roller 203, the glass substrate will be released and unloaded from conveying belt 204, and material of sufficient thickness deposited on conveying belt 204 will peel or flake off of conveying belt 204, falling to the bottom or floor of the chamber (not shown). In one embodiment, elastomeric buttons 205 will facilitate the peeling of material deposits from conveying belt 204. In one embodiment, the conveying surface further comprises a surface treatment of a nonstick material to further facilitate the peeling of material deposits from conveying belt 204.

In one embodiment, at least one heat exchanging device, such as a cooling plate, may be located between two or more rollers under a portion or segment of the conveying stretch of the conveying belt opposite the conveying surface. As shown in FIG. 2, in one embodiment, at least one primary cooling platen 208 may be located under a portion of conveying stretch 204a such that a substrate being conveyed may be cooled to prevent overheating due to chamber conditions. For example, the sputtering device 220 may generate a substantial amount of heat within the chamber. In another embodiment, as shown in FIG. 2, secondary cooling platens 209 and 210 may also be placed under portions of the return stretch 204b of conveying belt 204, opposite the conveying surface and within belt conveyor 200, in order to further cool conveying belt 204. Any number of secondary cooling platens may be placed under the return stretch 204b of conveyor belt 204, depending on the application. Cooling platens 208, 209 and 210 may be cooled using cooling water or other means for cooling.

In one embodiment, as shown in FIG. 2, the belt conveyor 200 may further comprise a cleaning brush adjacent to a conveying surface of conveying belt 204 at a location on return stretch 204b that sweeps the conveying surface to further remove material deposited on the conveying surface. In one embodiment, the cleaning brush may rotate on a roller portion, such as cleaning brush roller 206, so as to rotate alongside conveying belt 204. For example, the cleaning brush roller 206 may be located at a spot on the return stretch 204b after the conveying belt 204 bends around roller 202. In one embodiment, the cleaning brush roller 206 may be coupled to some form of driver, such as a motor and an interposed gear box (not shown). In one embodiment, the cleaning brush roller 206 may be independently driven and only activated occasionally. In another embodiment, the cleaning brush roller 206 may be independently driven and activated continuously as the conveying belt 204 rotates around the rollers 201, 202 and 203. In yet another embodiment, the cleaning brush roller 206 may be coupled to the roller 202 by means of a belt 207 so that rotation of roller 202 drives the rotation of cleaning brush roller 206. In one embodiment, the cleaning brush roller 206 may be overdriven such that it rotates at a faster speed than conveying belt 204. The cleaning brush roller 206 may rotate in either direction in relation to the travel direction of conveying belt 204 at the location where cleaning brush roller 206 and conveying belt 204 meet.

In yet another embodiment, as shown in FIG. 2, a shield 211 may be removably attached to the belt conveyor 200 to deflect debris or sputter and prevent the debris from flying onto the trailing edge of a substrate being conveyed as the debris peels from the surface of the conveyor belt 204 or is brushed off from the surface of conveying belt 204. The shield 211 may be removably secured to the belt conveyor 200 by one or more screws, rivets, or other fasteners. The shield 211 can be made from metal. The shield 211 can be sufficiently long to block any debris from flying onto the trailing edge of a substrate being conveyed, depending on the overall size of the belt conveyor.

In one embodiment, a method of conveying substrates from a starting point to a destination point along a predetermined path is provided. Referring to the embodiment of the belt conveyor illustrated in FIG. 2, this method comprises placing one or more substrates on a belt conveyor 200, the belt conveyor having a motorized roller 202 and at least two other rollers 201 and 203, wherein the motorized roller and the two other rollers are positioned at a distance from one another and in a nonaligned arrangement. In this embodiment, at least one endless conveying belt 204 is tensioned around the motorized roller 202 and the two other rollers 201 and 203, wherein the conveying belt defines a conveying surface having one or more raised elastomeric areas (see 205) thereon for releasably supporting the substrates and provides a substrate-conveying stretch and a return stretch. The motorized roller 202 is operable to drive the conveying belt 204 to move the substrates on the conveying belt along the belt conveyor 200. This method further comprises engaging a surface of the conveying belt using the motorized roller 202 to drive the conveying belt 204 via rotation of the motorized roller 202. The conveying belt 204 is tracked around the rollers via engagement of the surface of the conveying belt with the rollers, wherein the conveying surface moves along the predetermined path, and material deposited on the conveying surface peels off of the conveying surface as the conveying belt 204 bends around the rollers on the return stretch. The substrates are removed from the conveying belt at the destination point.

In one embodiment, the method of conveying substrates from a starting point to a destination point along a predetermined path further comprises sweeping deposited material from the conveying surface using a cleaning brush disposed adjacent to the conveying surface at a location on the return stretch. In another embodiment, the method further comprises cooling the conveying belt using at least one cooling plate positioned between two rollers under a segment of the conveying belt opposite the conveying surface.

FIG. 3 is an enlarged partial side cross-sectional view of a section of one embodiment of a self cleaning belt conveyor. FIG. 3 shows an embodiment wherein one or more of the rollers 101, 102, or 103 may have one or more crowns or bumps 325 protruding from their exterior surface to assist in tracking the conveying belt (see FIG. 3).

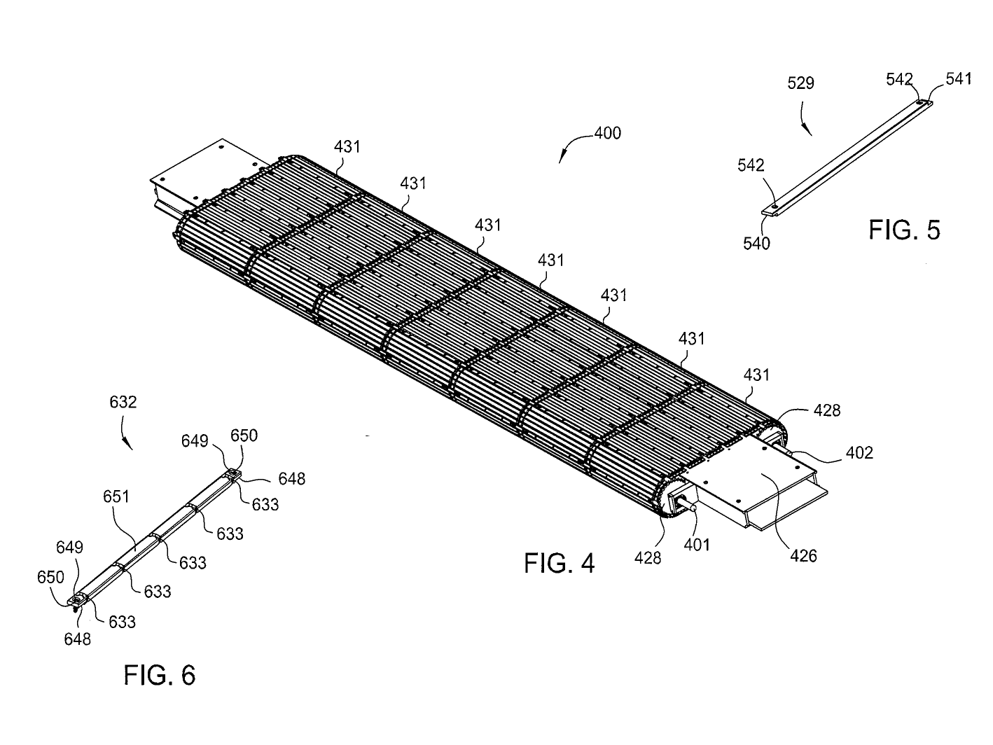

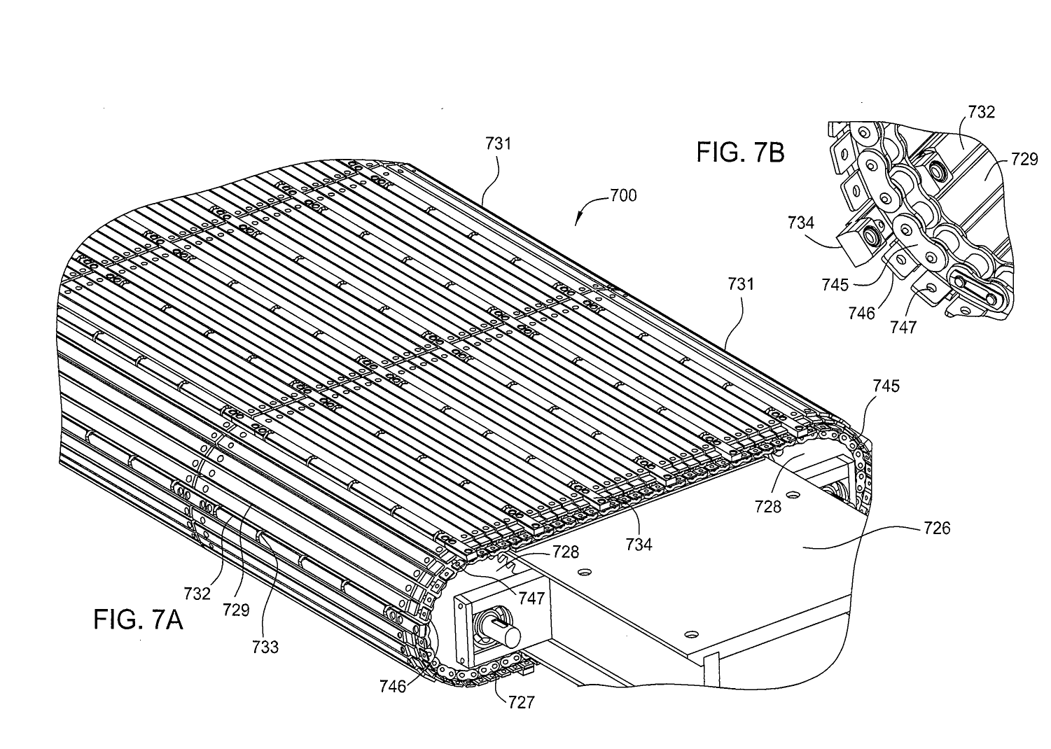

FIG. 4 shows another embodiment of a self cleaning belt conveyor comprising a chain driven continuous caterpillar track 431. As shown in FIG. 4, the belt conveyor 400 may comprise two or more adjacent caterpillar tracks 431. Each caterpillar track 431 may be coupled with and driven by at least two chains (only one chain is shown as 727 in FIG. 7A). Each chain 727 may be supported on and rotated about at least two sprockets 428 (see also 528 in FIG. 5). The sprockets 428 may have teeth that engage the chain 727 as it moves about each sprocket 428. The chain may be a commercially available attachment chain, and may be made of metal. In one example, one sprocket 428 may be attached with a portion of a drive shaft 401, said drive shaft 401 being longitudinally parallel to, and on one side of a supporting frame 426 which may itself be supported within the chamber. Another sprocket 428 may be attached to a portion of another drive shaft 402, said other drive shaft 402 being longitudinally parallel to, and on the opposite side of frame 426 as drive shaft 401. Each drive shaft 401 and 402 may be supported by and rotatably coupled to the frame 426 using a coupling mechanism, such as bearings (see 730 in FIG. 7A).

Drive shafts 401 and 402 may be coupled to a motor (not shown) which may rotate each drive shaft 401 and 402 and sprocket 428, thus driving chain 727 about sprockets 428. The movement of chain 727 in turn moves caterpillar track 431 around drive shafts 401 and 402. During operation of the belt conveyor 400, sprockets 428 will move in the same direction, the direction of movement of caterpillar track 431. For example, sprockets 428 will all rotate in a clockwise direction, or sprockets 428 will all rotate in a counter-clockwise direction, depending on the desired direction of movement of caterpillar track 431. A tensioner (not shown) may be used to maintain proper tension in the chain 727 for constant engagement of chain 727 on sprockets 428.

The embodiment of FIG. 4 is shown more closely in FIG. 7A. Belt conveyor 700 may include a chain-driven continuous caterpillar track 731 comprising a plurality of slats coupled with the chain 727. The slats of caterpillar track 731 may be parallel and adjacent to one another. In one embodiment, the caterpillar track 731 may be comprised of two different types of slats, a first type of slat 729 and a second type of slat 732. As shown in more detail in FIG. 5, each slat 529 (slat 729 in FIG. 7A) of the first type may be long and planar, with an overhang 540 at one distal end and an underhang 541 at another distal end. Each slat 529 may also have a hole 542 at each distal end to accommodate a fastening mechanism, such as a screw or rivet. Hole 542 may be located at a portion of slat 529 between overhang 540 and underhang 541.

A more magnified view of the embodiment of FIG. 7A (albeit from a different angle) is shown in FIG. 7B. Each link 745 of chain 727 may comprise at least two tabs 746 protruding from, and perpendicular to, each side of the link 745 (only one tab 746 for each link 745 is visible in FIG. 7A). Tabs 746 may be used to secure the plurality of slats of caterpillar track 731 to chain 727. Tabs 746 may protrude from each outer face of chain 727 and may be disposed parallel to the slats 729 on caterpillar track 731 such that each underhang (see 541 in FIG. 5) of each slat 729 may rest flat against a tab 746 on the side of chain 727 from which the tab 746 protrudes. Each tab 746 may have a hole 747 to accommodate a screw or rivet. Each hole 542 (see FIG. 5) at each distal end of each slat 729 may correspond with a hole 747 on one tab 746 of each link 745 of chain 727 when each slat 529 is positioned over the chain 727. In order to assemble the caterpillar track 731 of the belt conveyor 700, one distal end of each slat 729 may be attached or secured to a tab 746 on one chain 727 using screws or rivets going through holes 542 and 747, and the other distal end of slat 729 may be attached in the same manner to a tab 746 on a parallel chain 727. In this manner, each slat 729 is supported on each end by a different chain 727.

The second type of slat 732 may also form the caterpillar track 731 of the belt conveyor 700. As shown in more detail in FIG. 6, each slat 732 (slat 632 in FIG. 6) may be long and planar, similar to slat 729, but shorter in length and with overhangs 648 at each distal end. Slat 632 may also have holes 649 at each overhang 648 to accommodate a screw 650 or rivet. Each slat 632 may have at least one raised component 633 on conveying surface 651 of slat 632 such that a glass or substrate being conveyed on caterpillar track 731 may be raised above the conveying surface 651 such as to avoid direct contact with the conveying surface 651. In some embodiments, slat 632 may include one, two, three, or more raised components 633, depending on the application. The raised components 633 may be disposed at different portions of slat 632 and may be spaced regularly or irregularly. The at least one raised component 633 may be an elastomeric o-ring wrapped around slat 632 at a certain point along the length of the slat 632. Slat 632 may also have a groove to accommodate the o-ring and keep it in place. The at least one raised component 633 may also be in the form of a button or stud attached to the conveying surface 651 of the slat 632. For example, the button or stud may be screwed into the slat 632 or adhered to the conveying surface 651.

The raised component 633 may be made of silicon or an elastomer that is compatible with the process being carried out in the chamber where the belt conveyor 700 is located. It should be noted that in some embodiments, at least one slat of the first type 729 may also comprise at least one raised component on its conveying surface, similar to the raised component 633 on slat 632, as described above. Therefore, slats 732, or slats 729, or both, may comprise raised components as described above. These raised components may be of the same type or different from slat to slat. For example, slats 729 may have elastomeric studs disposed thereon while slats 732 may comprise o-rings. The type, number, and location of raised components may depend on the application.

Each slat 732 may be positioned at intervals between slats 729. For example, track 731 may have five consecutive slats of the first type, slat 729, followed by one slat of the second type, slat 732, followed by five consecutive slats of the first type, slat 729, and so on, to form a repetitive pattern throughout track 731, as shown in FIG. 7A. The number, frequency and patterns of slats of the first and second type may vary, thereby forming an irregular pattern. In another embodiment, there may be ten slats of the first type in between each slat 732, or there may be two slats of the first type in between each slat 732. In yet another embodiment, the number of slats of the first type may vary between each slat 732. Different combinations and patterns of types of slats 729 and 732 may be used.

A connector 734 may be used to couple each slat 732 to links on each chain 727 supporting track 731. The connector 734 may be shorter in length than slat 732, and it may have an underhang at each distal end. The connector 734 may have four holes, one at each underhang and one at each distal end between the underhangs. In this manner, each hole in the underhang may line up with a hole 649 (see FIG. 6) in the overhang of slat 732 such that a screw or rivet may be used to couple slat 732 to connector 734, as shown in FIG. 7A. A quarter-turn quick removal screw, such as shown at 650 in FIG. 6, may be used to couple slat 732 to connector 734. The two holes in between the overhangs of connector 734 may line up with holes in the two tabs 746 protruding from each link 745 of chain 727. The connector 734 and the use of quick removal screws may allow for quick and easy removal of slat 732 for purposes of servicing, such as replacing an o-ring 733. This may be especially useful in embodiments of belt conveyor 700 comprising more than one caterpillar track 731.

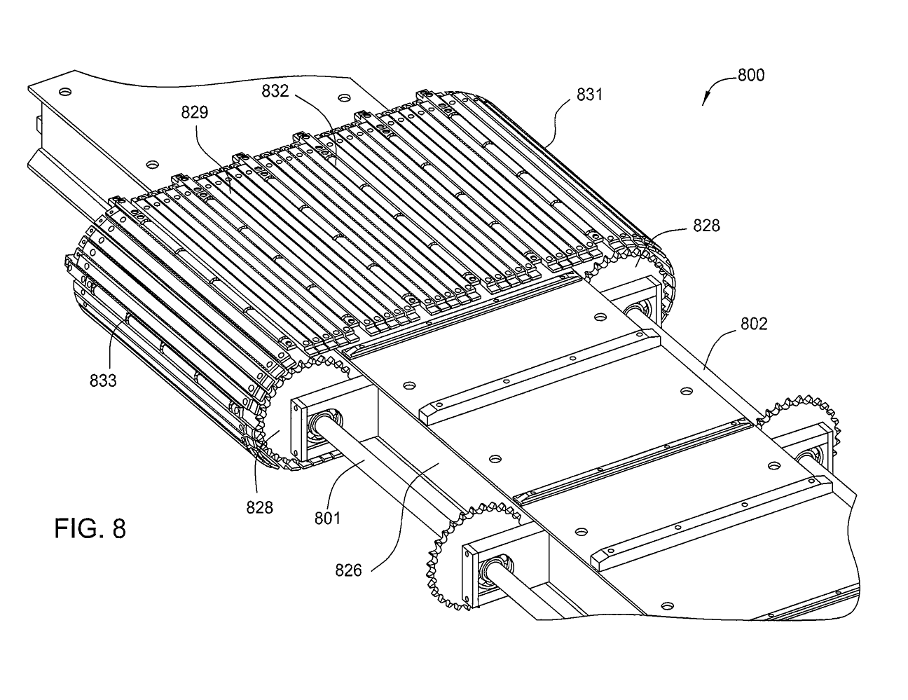

FIG. 8 shows one caterpillar track 831 of a belt conveyor 800 of the embodiment as described above with respect to FIGS. 4 and 7. Caterpillar track 831 is supported by two pairs of sprockets 828 (back two sprockets 828 are not visible in FIG. 8) coupled to shafts 801 and 802 on either side of frame 826. The chains (such as chain 727 in FIG. 7A) which, according to this embodiment, would couple with each slat of caterpillar track 831 are not shown in FIG. 8. The caterpillar track 831 comprises two types of slats, 829 and 832, as described above. All slats are arranged adjacent to one another, and parallel to one another and to shafts 801 and 802. As shown in FIG. 8, caterpillar track 831 comprises a regular repeating pattern of five slats 829 followed by one slat 832. In the embodiment shown in FIG. 8, each slat 832 comprises five evenly spaced o-rings 833 (only one exemplary o-ring is labeled in FIG. 8), with each o-ring 833 secured onto each the slat 832 as described above with reference to FIG. 7A.

Although FIG. 8 shows only one caterpillar track 831, two or more caterpillar tracks 831 may be coupled together to form a wider conveying surface, depending on the width of the glass or substrate to be transported by the belt conveyor (see FIGS. 4 and 7). As described above in reference to FIGS. 7 and 7A, in one embodiment, one caterpillar track 731 may be coupled to a chain 727 using tabs 746 protruding from one side of links 745 of chain 727, while an adjacent caterpillar track 731 may be coupled to the same chain 727 using tabs 746 protruding from the other side of the links 745 of chain 727. In other words, each chain 727 may be configured to support two caterpillar tracks. In this embodiment, each connector 734 may couple neighboring slats 732 on adjacent caterpillar tracks 731. For example, connector 734 may be disposed between slats 732 on adjacent caterpillar conveyor tracks 731 such that connector 734 is coupled with a slat 732 and a tab 746 on one side of connector 734, and a slat 732 and a tab 746 on the other side of connector 734. Furthermore, as shown in FIG. 7A, the overhangs of slats 729 of one caterpillar track 731 may overlap with the underhangs of slats 729 on an adjacent caterpillar track 731 such that any gaps between adjacent caterpillar tracks 731 are minimized. This reduces deposition of debris and material inside the belt conveyor 700 or on the chain 727. Furthermore, as caterpillar track 731 bends about sprockets 728, material deposited on the conveying surface of caterpillar track 731 may peel or flake off of the slats. In this manner, the belt conveyor may be self-cleaning. Both the raised components and the curvature of the caterpillar track 731 about the sprockets 728 may facilitate the peeling or flaking of deposited material off the conveying surface of caterpillar track 731. The gap formed as a result of the raised component between the conveying surface and the glass or substrate being conveyed may be kept consistent because material is thus prevented from building up on the conveying surface of caterpillar track 731.

The spacing between adjacent slats of caterpillar track 731 should be wide enough with respect to the pitch of chain 727 to allow caterpillar track 731 to easily move about the sprockets 728, but narrow enough to minimize deposition of material inside of the belt conveyor 700.

The frame 726 may be made of a suitable strong and corrosion resistant material, such as stainless steel. The sprockets 728 and drive shafts 801 and 802 (shown in FIG. 8) may also be made of stainless steel or some other corrosion resistant material. Slats 729 and 732 should be of sufficient thickness in order to avoid wear and minimize replacements. They may be made from corrosion resistant aluminum or stainless steel, which may be electropolished to make it smooth so that material deposited on the glass or substrate being conveyed does not adhere to the conveying surface. As a result of using thicker and more process-resistant slats, the belt conveyor 700 may be operated without water cooling. However, if necessary, the belt conveyor may have a means for directing cooling fluid through drive shafts 401 and 402 (or 801 and 802).

In one embodiment, belt conveyor 700 may also comprise one or more brushes (not shown) disposed underneath a return stretch of caterpillar track 731 for sweeping deposited material or debris off the conveying surface. In one embodiment, a series of brushes may be staggered in an alternating fashion in order to obtain proper overlap between the brushes. In an alternate embodiment, belt conveyor 700 may comprise one continuous brush (not shown).

In another embodiment, each chain 727 may support only one caterpillar track 731 so that, in the embodiment having a plurality of caterpillar tracks 731 adjacent to one another to form a wider conveying surface, adjacent caterpillar tracks 731 are not coupled to one another, other than being driven by the same drive shafts. In this embodiment, adjacent caterpillar tracks 731 would not share the same chain or sprockets. Slats on each caterpillar track may still have underhangs and overhangs as described above so as to create overlap between slats of adjacent caterpillar tracks 731 to prevent gaps between the adjacent caterpillar tracks 731.

In one embodiment, a method of conveying substrates from a starting point to a destination point along a path is provided. Referring to the embodiment of the belt conveyor illustrated in FIGS. 4-8, this method comprises placing one or more substrates on a belt conveyor 700, the belt conveyor having a frame 726, at least two motorized drive shafts (see 801 and 802 shown in FIG. 8) supported by the frame 726 and connectable to a motor (not shown in FIG. 7A), and at least two parallel chains 727, wherein each chain 727 is actively engaged with at least two sprockets 728 coupled with the at least two drive shafts. The belt conveyor 700 further comprises a caterpillar track 731, wherein the caterpillar track 731 is coupled with the at least two parallel chains 727 and has a conveying surface comprising at least one raised component for supporting the substrate and wherein the caterpillar track 731 provides a substrate-conveying stretch and a return stretch. The method further comprises rotating the at least two drive shafts to move the sprockets 728. Rotation of the at least two drive shafts and sprockets 728 will drive the at least two parallel chains 727 such that the caterpillar track 731 moves around the at least two drive shafts. The conveying surface may move along the path and material deposited on the conveying surface may peel off of the conveying surface as it moves around sprockets 728. The substrate thereby moves on the conveying surface along the belt conveyor. The substrates may be removed from the conveying belt at the destination point.

The method may further comprise sweeping deposited material from the conveying surface using a cleaning brush (not shown) disposed adjacent to the conveying surface at a location on the return stretch.

While the embodiments of the methods of the present invention are described in accordance with the embodiments of the belt conveyors illustrated in FIGS. 1-6, it should be noted that the methods are not limited to the belt conveyors as illustrated in FIGS. 1-6, but may be used with other embodiments of belt conveyors as described above.

Although the invention has been described in accordance with certain embodiments and examples, the invention is not meant to be limited thereto. For instance, although some of the embodiments referred to herein describe the use of the self cleaning conveyor belt in a glass substrate processing chamber, it should be appreciated that the self cleaning conveyor belt can be used in a lower tunnel assembly as well.

While the foregoing is directed to embodiments of the present invention, other and further embodiments of the invention may be devised without departing from the basic scope thereof, and the scope thereof is determined by the claims that follow.

1. A belt conveyor apparatus for transporting a substrate through a chamber, the belt conveyor comprising:
at least one endless belt having a conveying surface, wherein the conveying surface comprises one or more raised components for supporting the substrate and maintaining a gap between the conveying surface and the substrate; and
two or more cylindrical shafts coupled with the at least one endless belt wherein the at least one endless belt is tensioned around the two or more cylindrical shafts and wherein the two or more cylindrical shafts are rotatable to move the conveying surface.

2. The belt conveyor apparatus of claim 1, wherein the raised components are elastomeric.

3. The belt conveyor apparatus of claim 1, further comprising a cleaning brush adjacent to the conveying surface at a location on a return stretch of the belt, so that the cleaning brush sweeps the conveying surface to remove material deposited on the conveying surface.

4. The belt conveyor apparatus of claim 3, wherein the cleaning brush is coupled with a motor so that the motor drives the cleaning brush.

5. A belt conveyor apparatus for transporting a substrate through a chamber, the belt conveyor comprising:
a frame;
at least two drive shafts supported by the frame and connectable to a motor;
at least two parallel chains, wherein each chain is actively engaged with at least two sprockets operatively coupled with the at least two drive shafts; and
a caterpillar track having a conveying surface, wherein the caterpillar track is mounted on the at least two parallel chains such that the caterpillar track is rotatable around the at least two drive shafts during rotation of the at least two drive shafts, and wherein the caterpillar track comprises at least one raised component on the conveying surface to form a gap between the conveying surface and the substrate.

6. The belt conveyor apparatus of claim 5, wherein the chains comprise links having protruding portions for mounting the caterpillar track thereon.

7. The belt conveyor apparatus of claim 5, further comprising additional caterpillar tracks, wherein the caterpillar tracks are mounted adjacent to one another onto one chain such that the caterpillar tracks are movable at the same speed and in the same direction.

8. The belt conveyor apparatus of claim 7, wherein each caterpillar track comprises a plurality of slats and each slat is coupled with a link on each chain, and wherein at least one slat comprises an overhang portion at one end and an underhang portion at the other end such that the slats of adjacent caterpillar tracks overlap with one another.

9. The belt conveyor apparatus of claim 5, wherein the caterpillar track comprises a plurality of slats and each slat is coupled with a link on each chain.

10. The belt conveyor apparatus of claim 9, wherein the at least one raised component comprises one or more o-rings disposed around at least one slat.

11. The belt conveyor apparatus of claim 5, wherein
the caterpillar track comprises a plurality of slats;
at least one slat comprises the at least one raised component and the at least one slat is coupled to each chain using a connector slat; and
the at least one slat is coupled to the connector slat using a screw.

12. The belt conveyor apparatus of claim 9, wherein at least one slat comprises overhangs at each end and wherein each end of the at least one slat is coupled with a link on each chain using a connector slat having an underhang at each end, wherein one overhang of the at least one slat overlaps one underhang of the connector slat.

13. The belt conveyor apparatus of claim 5, wherein the at least one raised component comprises an elastomeric material.

14. The belt conveyor apparatus of claim 5, further comprising a cleaning brush adjacent to the conveying surface at a location on a return stretch, wherein the cleaning brush sweeps the conveying surface to remove material deposited on the conveying surface.

15. A method of conveying a substrate from a starting point to a destination point along a path comprising:
placing a substrate on a belt conveyor, wherein the belt conveyor comprises a frame, at least two motorized drive shafts supported by the frame and connectable to a motor, at least two parallel chains, wherein each chain is actively engaged with at least two sprockets coupled with the at least two drive shafts, and a caterpillar track, wherein the caterpillar track is coupled with the at least two parallel chains and has a conveying surface comprising at least one raised component for supporting the substrate and wherein the caterpillar track provides a substrate-conveying stretch and a return stretch;
rotating the at least two drive shafts to move the sprockets and the at least two parallel chains such that the caterpillar track is driven around the at least two drive shafts, wherein the conveying surface moves along the path and material deposited on the conveying surface peels off of the conveying surface; and
moving the substrate on the conveying surface along the belt conveyor.

16. The method of claim 15, further comprising sweeping deposited material from the conveying surface using a cleaning brush disposed adjacent to the conveying surface at a location on the return stretch.
